(19) United States
(12) Patent Application Publication
(10) Pub. No.: US 2024/0059399 A1
(43) Pub. Date: Feb. 22, 2024

(54) A CAVITY

(71) Applicant: TUSAS- TURK HAVACILIK VE UZAY SANAYII ANONIM SIRKETI, Ankara (TR)

(72) Inventors: Engin TASKIRAN, Ankara (TR); Senol BASKAYA, Ankara (TR)

(21) Appl. No.: 18/269,061

(22) PCT Filed: May 24, 2021
(86) PCT No.: PCT/TR2021/050478

§ 371 Date: Jun. 22, 2023

(30) Foreign Application Priority Data
Dec. 30, 2020 (TR) 2020/22407

(51) Int. Cl. B64C 21/00; B64D 15/00; B64D 41/00

(52) U.S. Cl. CPC B64C 21/00; B64D 15/00; B64D 41/00; B64C 2025/003

(57) ABSTRACT

The invention relates to a body (2), a cavity (3) located on the body (2), enabling to place ammunition and similar payloads therein, a rear wall (4) which is the surface on which an airflow (AF) occurring with the movement of the body (2) leaves the cavity (3), and a floor (5) over which the airflow (AF) moves along the cavity (3).

This invention relates to the geometry of cavities in aerodynamic surfaces.

When aerodynamic surfaces are in motion, an air flow boundary layer forms thereon, forming a slip layer where the surface continuity ends. There are landing gear, ammunition payload and similar equipment in the cavities in air vehicles, which cause the surface continuity to end. Vibration problems, acoustic problems and turbulence occur in cavities due to the instability of the slip layer. Air vehicles are subjected to a challenging regime, especially when ammunition is dropped in high subsonic, transonic and supersonic flows. These unstable and strong structures formed in the flow area can cause structural and irreversible damages in terms of aerodynamics and aeroacoustics. Therefore, controlling the flow formed in the cavity enables the prevention of possible damages. There are active and passive methods available for controlling the air flow within the cavity. Passive methods are systems that operate without energy input. In active methods, in turn, it is necessary to supply external energy to operate the system.

The United States patent document US20190040883, which is included in the known state of the art, discloses changes made to the rear wall of a cavity in aircrafts in order to reduce cavity-induced vibrations and noises in areas such as ammunition storage and landing gear. In terms of the geometry of cavity, it is mentioned that the rear wall of the cavity is made completely convex.

With a cavity geometry developed by the present invention, it is enabled to reduce aeroacoustic noises caused by pressure fluctuations due to high-speed air flow.

An air vehicle developed to achieve the object of the invention, as defined in the first claim and in the claims dependent thereon, comprises a cavity disposed on aerodynamic surfaces, which are called bodies, and accommodating landing gears, ammunitions and similar equipment; a rear wall, which is the surface that the air flow formed by the movement of the body contacts at the end after proceeding along the cavity; and a floor, which is the surface that forms the length of the cavity, and on which a boundary layer formed by the air flow on the body proceeds as a slip layer along the cavity.

The air vehicle of the invention comprises a reinforcer having a layer that is positioned lengthwise on the rear wall of the cavity, produced in an inclined form and located so that it extends in the opposite direction to the air flow into the cavity, and that enables to reduce undesirable effects such as aeroacoustic noise and resonance caused by the air flow by widening the distance towards the interior of the cavity, between the part of the layer facing the floor and the floor itself.

In an embodiment of the invention, the air vehicle comprises an intersection edge that is the site of intersection of the rear wall, which is the last surface to be exposed to air flow in the cavity, with the floor of the cavity; a trailing edge that is the last part of the cavity to encounter the air flow; and an arc-shaped reinforcer that is mirror-symmetrically positioned on an axis extending perpendicular to the rear wall at an equal distance to the intersection edge and to the trailing edge.

In an embodiment of the invention, the air vehicle comprises a reinforcer with a curvature towards the interior of the cavity, one edge of the reinforcer being positioned on the intersection edge and the other edge thereof being positioned on the trailing edge.

In an embodiment of the invention, the air vehicle comprises a reinforcer with an arc angle that is determined according to a parameter obtained by proportioning the value of the cavity depth to the longest distance between the cavity rear wall and the layer.

In an embodiment of the invention, the air vehicle comprises a reinforcer that is produced from a piezoelectric material and thereby enables to generate electrical energy from pressure and stress acting thereon.

In an embodiment of the invention, the air vehicle comprises a reinforcer that is produced with a material having a porous structure and thereby reduces the level of aeroacoustic noise.

In an embodiment of the invention, the air vehicle comprises a reinforcer that enables to change the distance between the layer and the rear wall by reducing or increasing the arc angle thanks to manufacturing the reinforcer and the layer thereon with a flexible material.

In an embodiment of the invention, the air vehicle comprises a reinforcer manufactured in one piece with the rear wall of the cavity.

In an embodiment of the invention, the air vehicle comprises a reinforcer that can be attached to and detached from the rear wall of the cavity.

In an embodiment of the invention, the air vehicle comprises a reinforcer fabricated with a shape memory alloy, the reinforcer having a first position (I) wherein the reinforcer has the same form as the rear wall and thus shortens the length of the cavity only as the thickness of material when payloads such as landing gear or ammunition is present in the cavity, and a second position (H) wherein the reinforcer assumes an arc form on the rear wall by being triggered by a control unit for changing its shape when the lids of the cavity are opened for dropping ammunition or deploying the landing gear, the reinforcer being capable to switch between the first position (I) and the second position (II) by means of the control unit.

In an embodiment of the invention, the air vehicle comprises a reinforcer having a third position (Ill), wherein the lids of the cavity, in which payloads such as ammunition, landing gear is present, are closed and the reinforcer is located on the floor and therefore does not cause the length of the cavity to shorten, and a fourth position (IV), wherein the reinforcer comes onto the rear wall by being moved from the third position (III) by means of a robotic arm when ammunition is dropped or landing gear is put down with the opening of the cavity lids.

In an embodiment of the invention, the air vehicle comprises a reinforcer with at least one heater for removal or prevention of icing occurring on aerodynamic surfaces such as reinforcers due to free air flow taking place on the body.

The air vehicle realized to achieve the object of the present invention is shown in the accompanying figures, wherein from these figures;

FIG. 1 is a schematic view of the air vehicle and cavity.

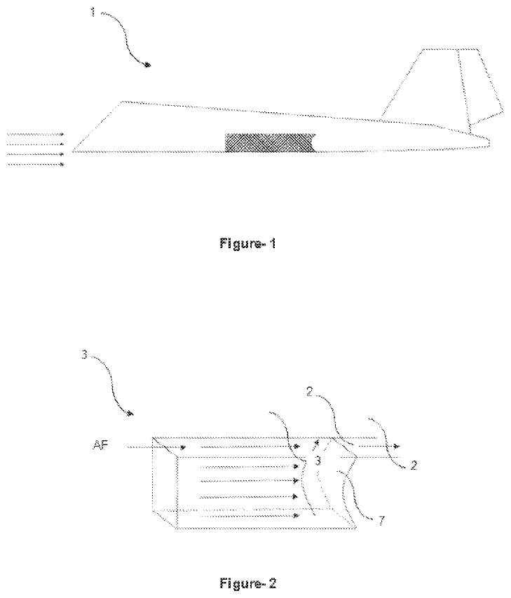

FIG. 2 is a perspective view of the cavity and the reinforcer,

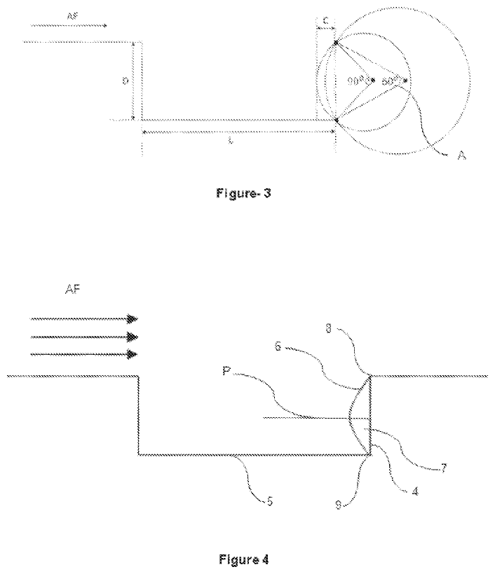

FIG. 3 is a schematic view of the cavity and the reinforcer.

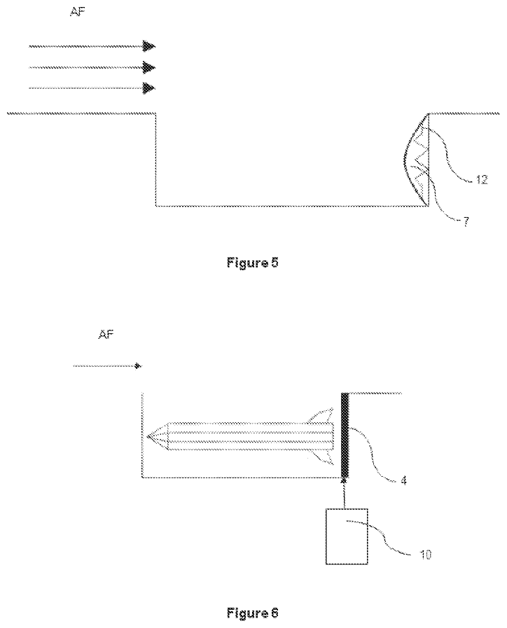

FIG. 4 is a schematic view of the cavity and the reinforcer.

FIG. 5 is a schematic view of the cavity, the reinforcer and the heater.

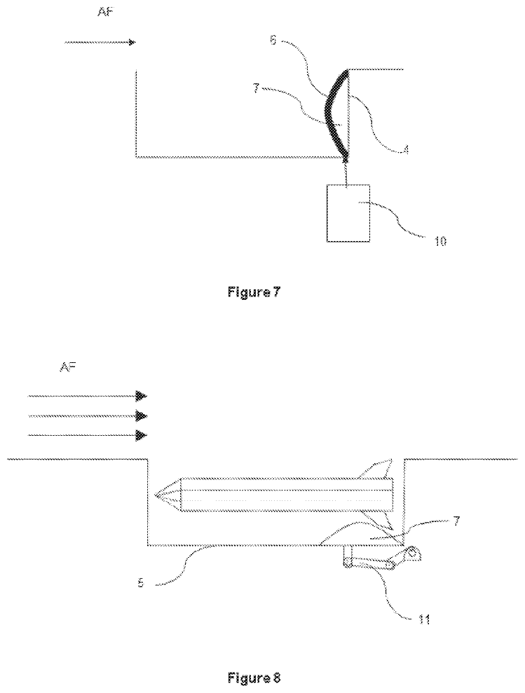

FIG. 6 is a schematic view of the layer, reinforcer, and control unit in the first position (I).

FIG. 7 is a schematic view of the layer, reinforcer, and control unit in the second position (II).

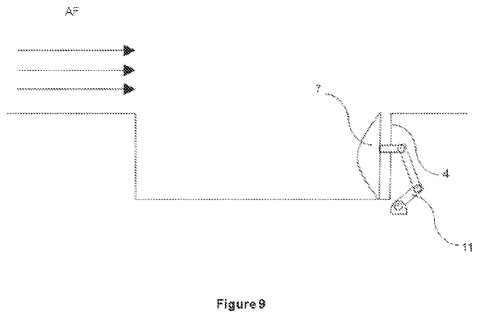

FIG. 8 is a schematic view of the reinforcer, cavity and robotic arm in the third position (HI) when payload is present.

FIG. 9 is a schematic view of the reinforcer, cavity and robotic arm in the fourth position (IV).

The parts illustrated in figures are individually assigned a reference numeral and the corresponding terms of these numbers are listed below.
1. Air vehicle
2. Body
3. Cavity
4. Rear wall
5. Floor
6. Layer
7. Reinforcer
8. Trailing edge
9. Intersection edge
10. Control unit
11. Robotic arm
12. Heater
(AF) Air flow
(P) Plane
(D) Depth
(C) Length
(A) Angle
(L) Height

The air vehicle (1) comprises a body (2), a cavity (3) located on the body (2), enabling to place ammunition and similar payloads therein, a rear wall (4) which is the surface on which an airflow (AF) occurring with the movement of the body (2) leaves the cavity (3), and a floor (5) over which the airflow (AF) moves along the cavity (3). (FIG. 1)

The air vehicle (1) of the invention comprises at least one reinforcer (7) having a curved layer (6) located lengthwise on the rear wall (4) and positioned so as to extend into the cavity (3), and a layer (6) that enables to reduce the noise level by reducing the pressure fluctuations caused by unstable air flow (AF) by widening the distance towards the interior of the cavity (3), between the part of the layer (6) facing the floor (5) and the floor (5) itself. (FIG. 2)

A boundary layer formed by the air flow (AF) on aerodynamic surfaces, the so-called body (2), deteriorates when it reaches the gaps, the so-called cavities (3), in the body (2) and creates a slip layer. The air flow (AF) advancing in the cavity by the movement of the body (2) proceeds along the floor (5) of the cavity (3) and finally contacts the rear wall (4).

By decreasing high pressure levels on the rear wall (4), it is ensured that the aircraft (1) flies in low visibility, the risk of being caught by radar is reduced, the drag force exposed to is decreased, the aerodynamic heating is reduced, the maneuverability of the air vehicle (1) is enhanced, and the survival and service life of the air vehicle is increased. The pressure levels are reduced by changes made on the geometry of the rear wall (4). Changes made on the rear wall 4 are carried out by attaching to the rear wall (4) an apparatus called the reinforcer (7) having a layer (6). The opening of the cavity (3) lids for the use of ammunition or landing gear-like payloads contained in open or closed cavities (3) causes gaps to occur in the body (2) and destabilizes the airflow (AF). Therefore, there is a layer (6) positioned in the cavity (3) in the opposite direction to the air flow (AF), said layer having a bent form, produced in one-piece with the rear wall (4) of the cavity (3), or being detachably attached to the rear wall (4) of the cavity (3), and located on the rear wall (4) so as to cover the rear wall (4). The distance between the part of the layer (6) towards the floor (5) and the floor (5) itself is such that it increases in the direction from the rear wall (4) towards the interior of the cavity (3). The distance between the part of the layer (6) towards the body (2) and the floor (5), on the other hand, decreases towards the rear wall (4). Thanks to the reinforcer (7) having a layer (6) which is oriented towards the interior of the cavity (3), it is enabled to reduce the pressure fluctuations and to decrease the acoustic noises.

In an embodiment of the invention, the air vehicle (1) comprises an arc-shaped reinforcer (7), located so as to be mirror-symmetrical with respect to a plane (P) passing through the center of the rear wall (4) at an equal distance to a trailing edge (8), which is the edge at which the air flow (AF) leaves the cavity (3), and to an intersection edge (9), where the floor (5) and the rear wall (4) intersect each other. A slip layer occurs because the air flow (AF) forming a boundary layer on the body (2) deteriorates its stability with the cavity (3) located on the body (2). The slip layer formed by the air flow (AF) advancing along the floor (5) of the cavity (3) causes undesirable acoustic noises, vibrations and pressures to occur by hitting the rear wall (4), which is the last surface it contacts within the cavity (3). Turbulence-like air flow (AF) caused by hitting the rear wall (4) causes pressure fluctuations to occur, thereby constituting the main source of aeroacoustic noises. It comprises a reinforcer (7) having a mirror-symmetrical shape with respect to the plane (P) extending perpendicular to the rear wall (4) through an edge which is equidistant to the intersection edge (9) that is the central edge of the rear wall (4) and to the trailing edge (8). It is enabled to reduce the pressure fluctuations by means of the arc-shaped reinforcer (7). (FIG. 4)

In an embodiment of the invention, the air vehicle (1) comprises a reinforcer (7) extending so that one end thereof is positioned at the intersection edge (9) and the other end thereof at the trailing edge (8). Since the length of the arc-shaped layer (6) will increase when the angle (A) value for the arc whose two points are fixed increases, the bulginess of the reinforcer (7) produced increases too. The reinforcer (7), which is arc-shaped and extends between the intersection edge (9) and the trailing edge (8), enables to reduce pressure fluctuations caused by the air flow (AF), thus minimizing the aeroacoustic noise level.

In an embodiment of the invention, the air vehicle (1) comprises a reinforcer (7) produced by an angle (A) that is determined according to the coefficient (DIC) obtained by proportioning the depth (0) of the cavity (3) to the length (C) between the layer (6) and the rear wall (4). In order to determine a suitable parameter for changing the geometry of the rear wall (4) of the cavity (3) located on the air vehicle (1) according to its requirement and capacity; the value of the depth of the cavity (3) is divided by a value corresponding to the longest distance (C) between the arc-shaped reinforcer (7) located on the rear wall (4) and the rear wall (4) itself. With the parameter (DIG) obtained, the angle (A) of the arc shape to be provided to the reinforcer (7) is determined. Therefore, the arc-shaped reinforcer (7), which causes the length (L) of the cavity (3) to shorten, makes it impossible to fit a payload into the cavity (3). (FIG. 3)

In an embodiment of the invention, the air vehicle (1) comprises a reinforcer (7) produced by a piezoelectric material that enables electricity to be generated by the pressure acting on the layer (6). The reinforcer (7), which is made of piezoelectric material, generates electricity thanks to the mechanical effects acting on it due to the air flow (AF) it is exposed to.

In an embodiment of the invention, the air vehicle (1) comprises a reinforcer (7) produced by a material that enables the absorption of aeroacoustic noises. Thanks to the material having a porous structure, damage to the constructive elements of the air vehicle (1) is prevented and the pressure formed on the reinforcer (7) is absorbed.

In an embodiment of the invention, the air vehicle (1) comprises a reinforcer (7) produced by a flexible material that enables the length (C) between the layer (6) and the rear wall (4) to be changed. Thanks to the reinforcer (7) and the layer (6) produced by a flexible material, it is enabled to change the distance between the layer (6) and the rear wall (4). In this way, the length (L) of the cavity (3) is slightly shortened because the arc angle will be small when there is ammunition in the cavity (3) or when the landing gear is in a closed state, and the length (L) of the cavity (3) is shortened more because the arc angle will be relatively large when ammunition is dropped or when the landing gear is deployed.

In an embodiment of the invention, the air vehicle (1) comprises a reinforcer (7) fabricated in one-piece with the rear wall (4). A form that is resistant to high pressure levels is formed by a reinforcer (7) produced in one-piece with the rear wall (4).

In an embodiment of the invention, the air vehicle (1) comprises a reinforcer (7) detachably attached to the rear wall (4). When the reinforcer (7) is not produced in one-piece with the rear wall (4), there is a reinforcer (7) produced which is attached detachably to the rear wall (4) in order to minimize the effects such as vibration, aeroacoustic noise etc. caused by high pressure levels within the cavity (3). (FIG. 6, FIG. 7, FIG. 8, FIG. 9)

In an embodiment of the invention, the air vehicle (1) comprises a first position (I) wherein the reinforcer (7) has the same form as the rear wall (4) when there is payload in the cavity (3), a second position (II) to which the reinforcer (7) in the form of an arc on the rear wall (4) is brought from the first position (I) when ammunition is dropped or the landing gear is deployed, and a control unit (10) triggering the form change of the reinforcer (7) produced from a shape memory alloy between the first position (I) and the second position (II). Shape-memory alloys display transition between austenite and martensite phases under the influence of temperature and pressure. When there are payloads such as ammunition, landing gear etc. in the cavity (3), the reinforcer (7) produced from a shape memory alloy assumes the first position (I) on the rear wall (4), in the form of the rear wall (4). Since there will be sufficient space in the cavity (3) when the landing gear is deployed or ammunition is dropped, the reinforcer (7) enabling to reduce the pressure level is heated and brought to the second position (II) where it is in the form of an arc. The form change of the reinforcer (7) between the first position (I) and the second position (II) is controlled by the control unit (10). (FIG. 6, FIG. 7)

In an embodiment of the invention, the air vehicle (1) comprises a third position (Ill) of the reinforcer (7) wherein the reinforcer is located on the floor (5) when there is payload in the cavity (3), a fourth position (IV) of the reinforcer (7) wherein the reinforcer is brought onto the rear wall (4) from the third position (Ill) when ammunition is dropped or landing gear is deployed, and a robotic arm (11) that enables the reinforcer (7) to be moved from the third position (III) to the fourth position (IV). When there are payloads such as ammunition, landing gear etc. in the cavity (3) and if the length (L) of the cavity (3) is not sufficient, the position of the reinforcer (7) is changed between the rear wall (4) and the floor (5) by means of the robotic arm (11), The position of the reinforcer (7) on the floor (5) is called the third position (Ill) and the position of the reinforcer (7) on the rear wall (4) is called the fourth position (IV). (FIG. 8, FIG. 9)

In an embodiment of the invention, the air vehicle (1) comprises at least one heater (12) located in the reinforcer (7) and preventing icing of the reinforcer (7) arising from the air flow (AF) on the body (2) and/or due to atmospheric conditions. Problems such as icing occur on the aircraft (1) due to atmospheric conditions and air flow (AF). A heater (12) is provided in the reinforcer (7) to eliminate or prevent the icing problem. Thanks to the heat energy emitted by the heater (12), it is ensured that the icing that may occur or have occurred on and around the reinforcer (7) can be prevented and/or eliminated in an effective and reliable manner. (FIG. 5)

1. An air vehicle (1) comprising:
a body (2),
a cavity (3) located on the body (2), enabling to place ammunition and similar payloads therein,
a rear wall (4) which is the surface on which an airflow (AF) occurring with the movement of the body (2) leaves the cavity (3),
a floor (5) over which the airflow (AF) moves along the cavity (3), and
at least one reinforcer (7) having a layer (6) with a curved form, located lengthwise on the rear wall (4) and positioned so as to extend into the cavity (3), said layer (6) enabling to reduce the noise level by decreasing the pressure fluctuations caused by unstable air flow (AF) by widening the distance towards the interior of the cavity (3), between the part of the layer (6) facing the floor (5) and the floor (5) itself.

2. The air vehicle (1) as claimed in claim 1, wherein the reinforcer (7) with an arc shape is located so as to be mirror-symmetrical with respect to a plane (P) passing through the center of the rear wall (4) at an equal distance to an trailing edge (8), which is the edge at which the air flow (AF) leaves the cavity (3), and to an intersection edge (9), where the floor (5) and the rear wall (4) intersect each other.

3. The air vehicle (1) as claimed in claim 2, wherein the reinforcer (7) extends so that one end thereof is positioned at the intersection edge (9) and the other end thereof is positioned at the trailing edge (8).

4. The air vehicle (1) as claimed in claim 1, wherein the reinforcer (7) is produced by an angle (A) that is determined according to a coefficient (D/C) obtained by proportioning the depth (D) of the cavity (3) to the length (C) between the layer (6) and the rear wall (4).

5. The air vehicle (1) as claimed in claim 1, wherein the reinforcer (7) is produced by a piezoelectric material that enables electricity to be generated by the pressure acting on the layer (6).

6. The air vehicle (1) as claimed in claim 1, wherein the reinforcer (7) is produced by a material that enables the absorption of aeroacoustic noises.

7. The air vehicle (1) as claimed in claim 1, wherein the reinforcer (7) is produced by a flexible material that enables the length (C) between the layer (6) and the rear wall (4) to be changed.

8. The air vehicle (1) as claimed in claim 1, wherein the reinforcer (7) is produced in one-piece with the rear wall (4).

9. The air vehicle (1) as claimed in claim 1, wherein the reinforcer (7) is detachably attached to the rear wall (4).

10. The air vehicle (1) as claimed in claim 9, comprising a first position (I) of the reinforcer (7) wherein the reinforcer has the same form as the rear wall (4) when there is payload in the cavity (3), a second position (II) to which the reinforcer (7) in the form of an arc on the rear wall (4) is brought from the first position (I) when ammunition is dropped or the landing gear is deployed, and a control unit (10) triggering a form change to occur in the reinforcer (7) produced from a shape memory alloy between the first position (I) and the second position (II).

11. The air vehicle (1) as claimed in claim 9, comprising a third position (III) of the reinforcer (7) wherein the reinforcer is located on the floor (5) when there is payload in the cavity (3), a fourth position (IV) of the reinforcer (7) wherein the reinforcer is brought from the third position (III) onto the rear wall (4) when ammunition is dropped or landing gear is deployed, and a robotic arm (11) that enables the reinforcer (7) to be moved from the third position (III) to the fourth position (IV).

12. The air vehicle (1) as claimed in claim 1, comprising at least one heater (12) located in the reinforcer (7) and preventing icing of the reinforcer (7) arising from the air flow (AF) on the body (2) and/or due to atmospheric conditions.
